(19) United States
(12) Patent Application Publication
(10) Pub. No.: US 2012/0016918 A1
(43) Pub. Date: Jan. 19, 2012

(54) Method for Compressing Information

(76) Inventor: Jae Won Oh, Seoul (KR)

(21) Appl. No.: 13/092,805

(22) Filed: Apr. 22, 2011

(30) Foreign Application Priority Data
Jul. 16, 2010 (KR) 10-2010-068955

(51) Int. Cl. G06F 7/491

(52) U.S. Cl. 708/203

(57) ABSTRACT

Provided is a method of compressing information. The method includes converting compression target information into a binary number, converting the binary number into a decimal number a, performing operation of a discriminant

$$S = \frac{1 + \sqrt{1 + 8 a}}{2}$$

and obtaining a result S of the discriminant in order to operate “b” and “k” of a one-to-one correspondence function of the decimal number, obtaining “b” and “k” as a result of the discriminant, determining whether or not compression target information can be compressed based on the obtained “b” and “k” and the decimal number, and obtaining “b”, “k”, and least significant digit of the compression target information converted into binary number by repeating the first to third steps until it is determined that the compression target information can be compressed, and outputting a compressed information by incorporating the obtained “b”, “k”, and least significant digit of the binary number, wherein the least significant digit of the compression target information converted into binary number is removed and input as the compression target information during the repeating.

### CROSS-REFERENCE TO RELATED APPLICATION

This application claims priority to Korean Patent Application no. 10-2010-068955, filed on Jul. 16, 2010, which is hereby incorporated by reference for all purposes.

### BACKGROUND OF THE INVENTION

1. Field of the Invention

The present invention relates to a method of compressing information, and more particularly, to a method of compressing information by which information can be managed for a backup by compressing information without analyzing information using a function.

2. Description of the Related Art

In general, conventional compression schemes usually focus on reduction of redundant codes based on continuity and repeatability of information.

A compression/decompression software program, Alzip®, widely used in the art is also a compression scheme based on continuity and repeatability of information.

First, a run length encoding (RLE) scheme is known as the simplest compression method, in which the same successive characters are reduced to a single character at once based on continuity of information.

For example, Supposing a case where 5 characters “a,” 4 characters “b,” 2 characters “c,” 4 characters “d,” and 6 characters “e” are successively concatenated, they can be compressed as follows according to the RLE scheme.

### Example 1

aaaaabbbbccddddeeeeee→a5b4c2d4e6,

From the Example 1 described above, it is recognized that 21 characters are reduced to 10 characters.

Such a RLE scheme is advantageous in that the compression/decompression speed is fast and programming is easy. Particularly, the RLE scheme has a high compression rate when the same characters are successively concatenated.

However, the RLE scheme disadvantageously has a low character compression rate in a typical case, that is, when the same characters are not repeated.

Next, there is known Huffman coding, which uses a fact that all characters are not transmitted with the same frequency.

The RLE scheme and the Huffman coding are employed in JPEG and MPEG, in which a small number of bits are allocated to the frequently used characters.

The compression process of the Huffman coding includes:

1. reading a file to be compressed and obtaining frequencies of each character;

2. generating a binary tree by connecting characters having the lowest frequency among them;

3. obtaining a value representing each character from the binary tree; and

4. creating a compressed file by converting characters of the file into representative values.

However, such a Huffman coding scheme is disadvantageous in that the processing speed is not fast because character frequencies are counted in an initial file, and the file should be read twice for actual compression. In addition, since information on the tree is stored together, the compression efficiency is accordingly degraded.

As a compression scheme applied from such a Huffman coding scheme, there is known a Lempel-Ziv-Welch (hereinafter, referred to as LZW) scheme.

The LZW scheme is a universal data compression algorithm created by Abraham Lempel, Jacob Ziv, and Terry Welch. In the LZW scheme, a table for the successive character strings is created while reading a file, and then, if an equal character string is found, the created table is referenced. GIF or TIFF formats also adopt the LZW codes.

However, the LZW scheme also fails to achieve optimal compression because data are limitedly analyzed.

### SUMMARY OF THE INVENTION

The present invention has been made to address the aforementioned problems, and is to provide an information compression method capable of compressing information without performing information analysis using a function to allow information to be managed for a backup.

The invention also provides an information compression method capable of compressing backup target information in a high speed using a function for a backup.

Other objectives of the invention would be apparently understood by those skilled in the art by reading the following description without limitation to the aforementioned ones.

According to an aspect of the present invention, there is provided a method of compressing information, the method comprising: a first step of, using a control unit, converting compression target information into a binary number and converting the binary number into a decimal number a; a second step of, using the control unit, performing operation of a discriminant

$$S = \frac{1 + \sqrt{1 + 8 a}}{2}$$

and obtaining a result S of the discriminant in order to operate “b” (a coordinate value on an abscissa) and “k” (a coordinate value on an ordinate) of a one-to-one correspondence function of the decimal number; a third step of, using the control unit, obtaining “b” and “k” based on an equation

$$b = s - a + \frac{( s - 1 ) ( s - 2 )}{2} , k = a - \frac{( s - 1 ) ( s - 2 )}{2}$$

if the obtained result of the discriminant is an integer, or obtaining “b” and “k” based on an equation

$$b = [ s ] + 1 - a + \frac{[ s ] ( [ s ] - 1 )}{2} , k = a - \frac{[ s ] ( [ s ] - 1 )}{2}$$

if the obtained result of the discriminant is not an integer (where, “a” denotes a decimal number corresponding to a binary number of input information, “b” denotes a coordinate value on an abscissa obtained by converting compression target information based on a function, “k” denotes a coordinate value on an ordinate obtained by converting compression target information based on a function); and a fourth step of, using the control unit, determining whether or not compression target information can be compressed based on the obtained “b” and “k” and the decimal number, and obtaining “b”, “k”, and least significant digit of the compression target information converted into binary number by repeating the first to third steps until it is determined that information can be compressed, and outputting a compressed information by incorporating the obtained “b”, “k”, and least significant digit of the binary number, wherein the least significant digit of the compression target information converted into binary number is removed and input as the compression target information during the repeating, and it is determined that the compression target information can be compressed when an equation [log₂a]>[log₂b]+[log₂k]+1 is satisfied (herein, a square bracket “[ ]” as used in [S] or [log] denotes an greatest integer function, by which any real number can be expressed as an integer by neglecting digits below a radix point), and it is determined that the compression target information can be compressed when S≧23, and “b” or “k” is smaller than

$$\frac{1}{8} S .$$

### BRIEF DESCRIPTION OF THE DRAWINGS

FIG. 1A is a flowchart illustrating an information compression method according to an exemplary embodiment of the invention.

FIG. 1B is a flowchart illustrating a process of converting “a” of FIG. 1A into corresponding “b” and “k.”

FIG. 2 is a schematic diagram illustrating a characteristic of a function according to an exemplary embodiment of the invention.

FIGS. 3 and 4 are flowcharts illustrating a process of compressing information “110101011” using an information compression method according to an exemplary embodiment of the invention.

FIG. 5 is a flowchart illustrating a process of decompressing the compressed information using an information compression method according to an exemplary embodiment of the invention.

### DETAILED DESCRIPTION OF THE PREFERRED EMBODIMENTS

In an information compression method according to an exemplary embodiment of the invention, information is compressed using a function, for which a domain should be a natural number set, a range should be a subset of natural numbers, and a one-to-one correspondent inverse function should exist. In addition, the function should have a variable. If a function satisfying the following condition is found, information can be compressed for a backup.

In the following description, a square bracket “[ ]” as used in [S] or [log] denotes an greatest integer function, by which any real number can be expressed as an integer by neglecting digits below a radix point. For example, [3.141]=3, and [17.43]=17.

The information compression method according to an exemplary embodiment of the invention is adopted in controllers having a main control functionality, such as a computer or a mobile terminal (such as a mobile phone or a personal digital assistant (PDA)). Hereinafter, operations and actions of the invention will be described in detail by omitting a control unit as a main body for performing the information compression method.

The present invention proposes a technical configuration that has a mathematical characteristic as shown in Equation 1, in which information can be compressed only if a condition [log₂a]>[log₂b]+[log₂k]+1 should be satisfied.

ƒ:N₂→(N₂)², one-to-one function, ƒ:a→(b,k),

where, a condition [log₂a]>[log₂b]+[log₂k]+1 should be satisfied. In addition, N₂ denotes the set of natural numbers described as binary number, (N₂)² denotes the set of pairs of natural numbers, a denotes compression target data, that is, compression target information, b denotes a coordinate value on the abscissa converted by the aforementioned function, k denotes a coordinate value on the ordinate converted by the aforementioned function. The coordinate value b on the abscissa and the coordinate value k on the ordinate will be described in more detail below.

In the following description, while details of the information compression method according to an exemplary embodiment are provided for more general understanding of the present invention, those skilled in the art would appreciate that the invention may be readily embodied without those specific details or by modifications thereof.

Hereinafter, exemplary embodiments of the invention will be described in detail with reference to the accompanying drawings, focusing on those necessary to understand operations and actions of the present invention.

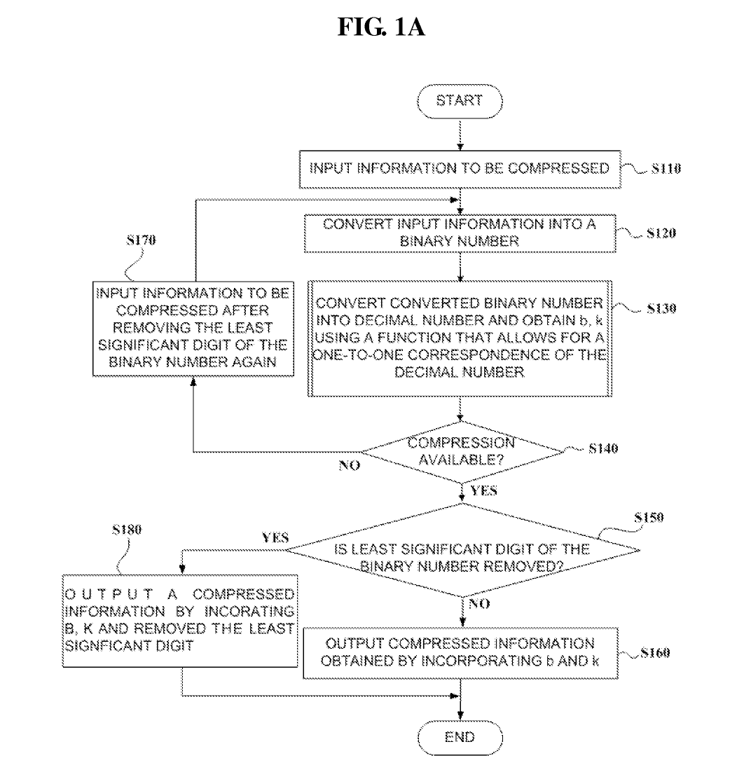

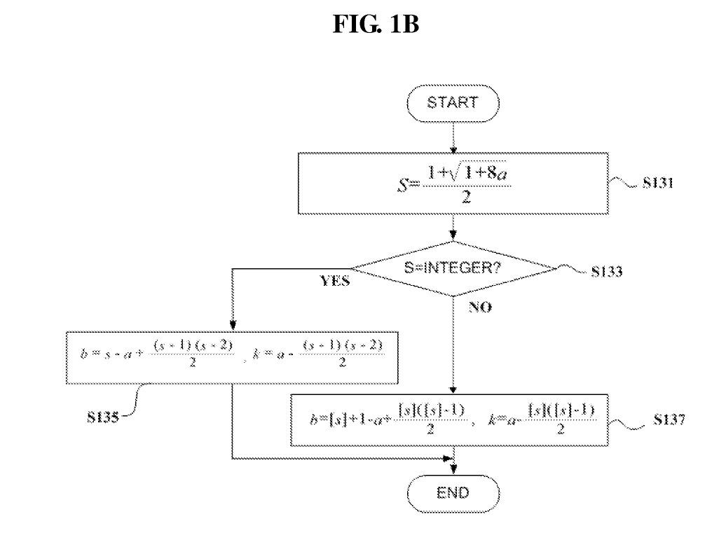

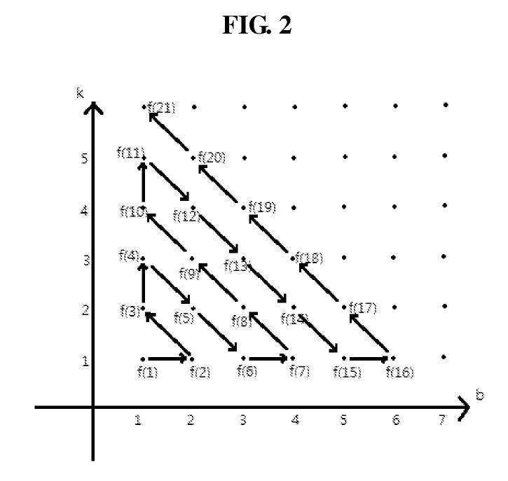

FIG. 1A is a flowchart illustrating an information compression method according to an embodiment of the invention, and FIG. 2B is a flowchart illustrating a process of converting “a” of FIG. 1A into corresponding “b” and “k.”

Referring to FIGS. 1A and 1B, data or information to be compressed are received (S110), and the input information is converted into a binary number (120).

The binary number converted in step S120 is converted into a decimal number a, and b and k are obtained using a specific function that allows for a one-to-one correspondence of the decimal number a (S130).

Here, the specific function will be described in detail with reference to FIG. 2.

Matching a domain from 1 as shown in FIG. 2, the abscissa represents a value of “b,” and the ordinate represents a value of “k” so that the compression target information “a” corresponds to a point (b, k) on a plane.

It is noted that a matching sequence is shown in FIG. 2 (however, points of FIG. 2 represent lattice points).

That is, “1” corresponds to (1,1), “2” corresponds to (2,1), “3” corresponds to (1, 2), “4” corresponds to (1,3),and “5” corresponds to (2,2).

If this is expressed mathematically, the specific function has characteristics as shown in Equations 2 and 4, which will be described below, and “b” and “k” are provided accordingly.

That is, in order to convert “a” into “b” and “k” as shown in FIG. 2, a discriminant of Equation 2 is applied as follows (S131).

$$S = \frac{1 + \sqrt{1 + 8 a}}{2} \qquad [ Equation 2 ]$$

Then, it is determined whether or not a result of the discriminant S obtained through the step S131 is an integer (S133).

If the result of the discriminant S is integer, “b” and “k” are obtained through the following Equation 3.

$$b = s - a + \frac{( s - 1 ) ( s - 2 )}{2} , k = a - \frac{( s - 1 ) ( s - 2 )}{2} \qquad [ Equation 3 ]$$

Otherwise, if the result of the discriminant S is not integer, “b” and “k” are obtained through the following Equation 4.

$$b = [ s ] + 1 - a + \frac{[ s ] ( [ s ] - 1 )}{2} , k = a - \frac{[ s ] ( [ s ] - 1 )}{2} \qquad [ Equation 4 ]$$

Then, it is determined whether or not information can be compressed using “b” and “k” obtained by converting a decimal number “a” corresponding to the binary number of the information input through the steps S135 and S137 based on the function (S140).

It is noted that whether or not information can be compressed is determined based on the following Equation 5, that is, if the Equation 5 is satisfied, information can be compressed.

[log₂a]>[log₂b]+[log₂k]+1 [Equation 5]

That is, the Equation 5 is to compare the size of the input information with the size of the information obtained by compressing and outputting the input information.

It is noted that information can be compressed when [log₂a] is greater than [log₂b]+[log₂k]+1.

There is another simple way to determine whether or not information can be compressed as follows.

Specifically, information can be compressed when S23, and “b” or “k” is smaller than

$$\frac{1}{8} S .$$

In this case, the input information is sufficiently large, the condition S≧23 would be satisfied naturally.

Therefore, a factor that determines whether or not information can be successfully compressed is “b” or “k,” that is, whether “b” or “k” is greater than or smaller than

$$\frac{1}{8} S .$$

If it is determined that information can be compressed as a result of the step S140, it is identified whether or not the least significant digit of the binary number of the input information has been removed (S150).

If it is determined that the least significant digit of the binary number of the input information has not been removed, it is recognized that the decimal number “a” of the input information can be compressed, and the compressed information is output by incorporating “b” and “k” (S160).

However, if it is determined that information cannot be compressed as a result of the step S140, information obtained by removing the least significant digit of the binary number of the input information is input again (S170).

In this manner, the process is repeated from the step S120 of converting the input information into a binary number to the step S140 of determining whether or not information can be compressed. It is noted that the process is repeated by removing the least significant digit of the input information until it is determined that information can be compressed.

If it is determined that the information obtained by removing the least significant digit of the binary number of the input information can be compressed, and it is identified that the least significant digit of the binary number of the input information has been removed in the step S150, “b,” “k,” and the removed information are incorporated and output as compressed information (S180).

For example, if the process of removing the least significant digit of the input information is repeated twice, and the removed least significant digit is “1” in a first try and “0” in a second try, information “01” is obtained to create a compressed file together with “b” and “k.”

Next, an example of the information compression method according to the present invention will be described to help understanding.

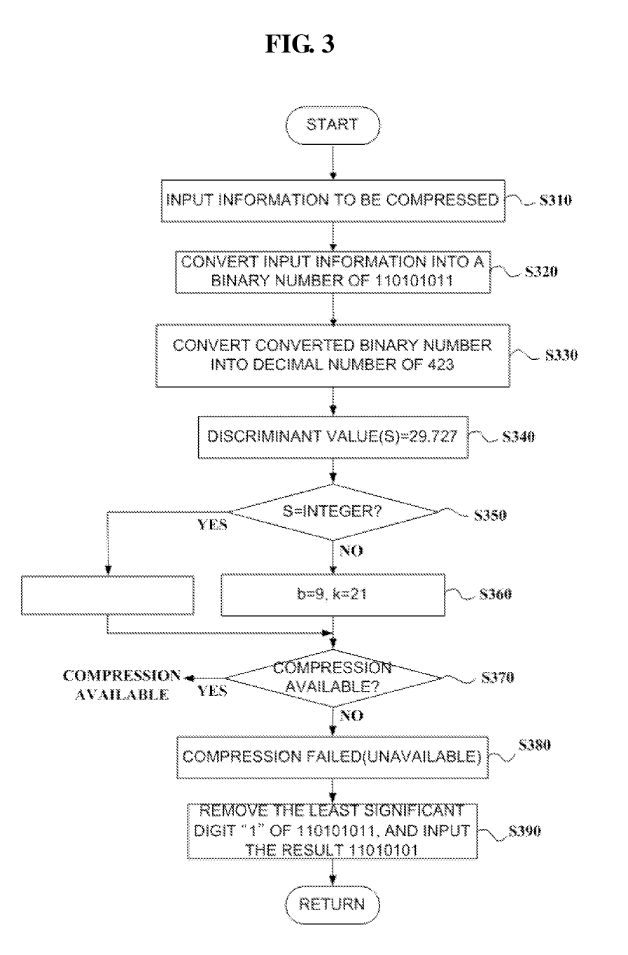

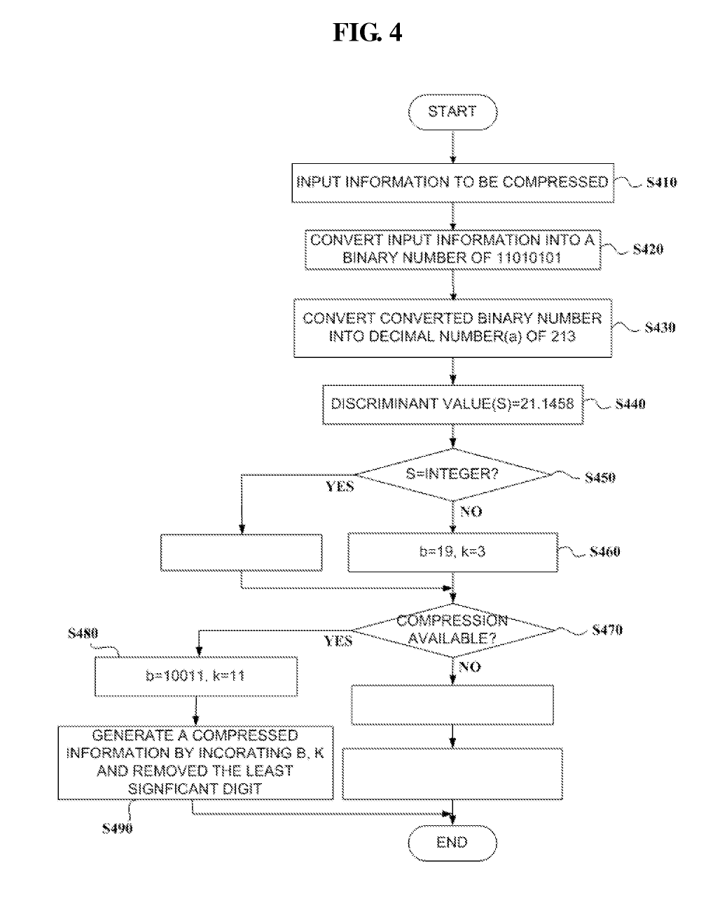

FIGS. 3 and 4 are flowcharts for illustrating a compression process when the information to be compressed using the information compression method according to the present invention is “110101011.” It is noted that, in FIGS. 3 and 4, some boxes are intentionally blanked to show unprocessed steps in each drawing.

Referring to FIGS. 3 and 4, first, compression target information is input (S310), and the input information is converted into a binary number “110101011” (S320).

Then, the resulting binary number is converted into a decimal number (a) “423” (S330), and the decimal number is substituted into the discriminant of Equation 2 so that a result of the discriminant is obtained as 29.727 (S340). Then, it is determined whether or not the obtained result of the discriminant is an integer (S350).

Since the result of the discriminant is not an integer, “b” and “k” are obtained by substituting the result of the discriminant “29.727” and the decimal number (a) “423” of the information input to the Equation 4 into the Equation 4.

As a result, “b=9” and “k=21” are obtained from the Equation 4 (S360).

Then, in order to determine whether or not information can be compressed, “b=9” and “k=21” obtained from the Equation 4 are substituted into the Equation 5 so that it is determined whether or not [log₂a] is greater than [log₂b]+[log₂k]+1 (S370).

As a result, since [log₂a] is smaller than [log₂b]+[log₂%]+1, it is determined that compression is not successful (S380), and the least significant digit “1” of “110101011” is removed so that information “11010101” is input (S390).

Then, the steps S420 to S470 corresponding to the aforementioned steps S320 to S370 are sequentially performed using information “11010101” newly input in the step S410 of FIG. 4.

Accordingly, “S=21.1458” is obtained a result of the discriminant. Since this is not an integer, “b=19” and “k=3” are obtained using the Equation 4.

Subsequently, it is determined whether or not information can be compressed in step S470. As a result, since [log₂a] is greater than [log₂b]+[log₂k]+1, it is determined that information can be compressed (S480). In this case, in order to determine whether or not information can be compressed, “b=19” and “k=3” are converted into binary numbers “b=10011” and “k=11.”

Then, a compressed file is created by incorporating “b,” “k,” and “the removed least significant digit” (S490).

Finally, since “b=10011,” “k=11,” and “the removed least significant digit=1,” “110101011” of the compression target information is represented as “10011,” “11,” and “1.” Accordingly, a compressed file becomes “10011+11+1→10011111” by incorporating “b=10011,” “k=11,” and “the removed least significant digit=1.” It is preferable that “b,” “k,” and “the removed least significant digit” are distinguishably stored so as to easily perform the subsequent decompression process.

The file compressed through the aforementioned process can be decompressed by reversing the aforementioned algorithm.

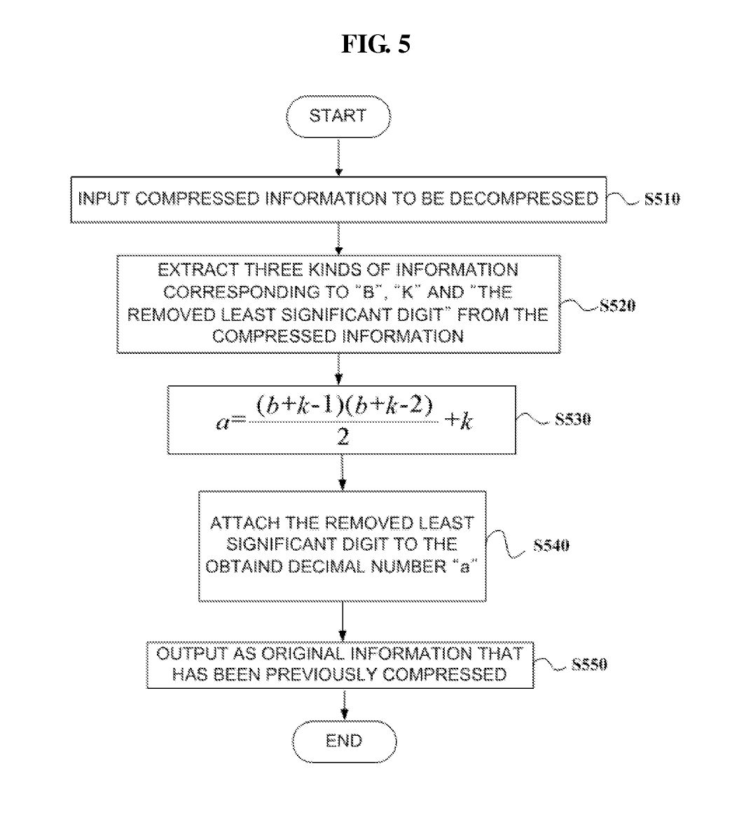

FIG. 5 is a flowchart illustrating a process of decompressing the information compressed through the information compression method according to an exemplary embodiment of the invention. In FIG. 5, description will be made by assuming that a compressed file is obtained by removing the least significant digit of the decimal number to be compressed.

Referring to FIG. 5, compressed information to be decompressed is input (S510).

Then, three kinds of information corresponding to “b,” “k,” and “the removed least significant digit” are extracted from the compressed information (S520). The corresponding information can be easily extracted if “b,” “k,” and “the removed least significant digit” are distinguishably stored.

In this case, information on the removed least significant digit may exist or not.

In other words, if it is determined that the decimal number “a” of the compression target can be compressed for a first try, it is not necessary to remove information on the least significant digit of the decimal number of the compression target information.

Then, “b” and “k” are substituted into the following Equation 6, and the original information on the decimal number “a” is obtained (S530).

$$a = \frac{( b + k - 1 ) ( b + k - 2 )}{2} + k \qquad [ Equation 6 ]$$

Then, the removed least significant digit is attached to the obtained decimal number “a” (S540), and the result is output as original information that has been previously compressed (S550).

In this case, when there is no removed least significant digit, the decimal number “a” obtained through the step S530 is output as original information that has been previously compressed.

While specific embodiments of the invention have been described hereinbefore, it would be appreciated that various modifications can be made without departing from the scope and spirit of the invention. Therefore, the scope of the invention is intended to be determined, not by the aforementioned embodiments, but by the claims attached below and equivalents thereof.

What is claimed is:

1. A method of compressing information, the method comprising:
a first step of, using a control unit, converting compression target information into a binary number and converting the binary number into a decimal number a;
a second step of, using the control unit, performing operation of a discriminant
$$S = \frac{1 + \sqrt{1 + 8 a}}{2}$$
and obtaining a result S of the discriminant in order to operate “b” (a coordinate value on an abscissa) and “k” (a coordinate value on an ordinate) of a one-to-one correspondence function of the decimal number;
a third step of, using the control unit, obtaining “b” and “k” based on an equation
$$b = s - a + \frac{( s - 1 ) ( s - 2 )}{2} , k = a - \frac{( s - 1 ) ( s - 2 )}{2}$$
if the obtained result of the discriminant is an integer, or obtaining “b” and “k” based on an equation
$$b = [ s ] + 1 - a + \frac{[ s ] ( [ s ] - 1 )}{2} , k = a - \frac{[ s ] ( [ s ] - 1 )}{2}$$
if the obtained result of the discriminant is not an integer,
where, “a” denotes a decimal number corresponding to a binary number of input information, “b” denotes a coordinate value on an abscissa obtained by converting compression target information based on a function, “k” denotes a coordinate value on an ordinate obtained by converting compression target information based on a function; and
a fourth step of, using the control unit, determining whether or not compression target information can be compressed based on the obtained “b” and “k” and the decimal number, and obtaining “b”, “k”, and least significant digit of the compression target information converted into binary number by repeating the first to third steps until it is determined that information can be compressed, and outputting a compressed information by incorporating the obtained “b”, “k”, and least significant digit of the binary number,
wherein the least significant digit of the compression target information converted into binary number is removed and input as the compression target information during the repeating, and it is determined that the compression target information can be compressed when an equation [log₂a]>[log₂b]+[log₂k]+1 is satisfied, (herein, a square bracket “[ ]” as used in [S] or [log] denotes an greatest integer function, by which any real number can be expressed as an integer by neglecting digits below a radix point), and it is determined that the compression target information can be compressed when S≧23, and “b” or “k” is smaller than
$$\frac{1}{8} S .$$

2. The method of claim 1, wherein the fourth step comprises:
identifying whether the least significant digit of the binary number of the input information has been removed, when it is determined that the information can be compressed;
in accordance with a result of the identifying,
outputting the compressed information obtained by incorporating “b”, “k” and the removed least significant digit of the binary number, when it is determined that the least significant digit of the binary number of the input information has been removed;
outputting the compressed information obtained by incorporating “b” and “k”, when it is determined that the least significant digit of the binary number of the input information has not been removed.

3. The method of claim 1, wherein further comprises:
extracting “b”, “k” and the removed least significant digit of the binary number of input information corresponding to compressed information to be decompressed;
obtaining the decimal number “a” of the original information by substituting the extracted “b” and “k” into an equation
$$a = \frac{( b + k - 1 ) ( b + k - 2 )}{2} + k ;$$
outputting the decimal number “a” as the decompressed information,
wherein, if the removed least significant digit of the binary number of input information is extracted, the obtained decimal number of the original information is converted into a binary number, and the removed least significant digit is attached to the converted binary number, and the decompressed information is output by converting the binary number attached the removed least significant digit into a decimal number.
